(19) United States
(12) Patent Application Publication
(10) Pub. No.: US 2023/0283593 A1
(43) Pub. Date: Sep. 7, 2023

(54) SYSTEMS AND METHODS FOR PROVIDING ACCESS TO APPLICATIONS AND SERVICES RUNNING ON A PRIVATE NETWORK

(71) Applicant: Venafi, Inc., Salt Lake City, UT (US)

(72) Inventors: Abhijit Dhariya, Salt Lake City, UT (US); Asquith Bailey, Salt Lake City, UT (US); Benjamin Skolmoski, Salt Lake City, UT (US); Daniel Elarde, Salt Lake City, UT (US); David Brancato, Salt Lake City, UT (US); Harigopan Nair, Salt Lake City, UT (US); Laurent Domenech, Salt Lake City, UT (US); Ryan Treat, Salt Lake City, UT (US); Walter Goulet, Salt Lake City, UT (US)

(21) Appl. No.: 17/685,123

(22) Filed: Mar. 2, 2022

(51) Int. Cl. H04L 9/40

(52) U.S. Cl. CPC H04L 63/0272; H04L 63/0435; H04L 63/0823

(57) ABSTRACT

Systems and methods for providing access to applications and services running on a private network are disclosed. A method for providing secure access to private network applications includes providing a client application accessible from a user device and a management application configured to communicate with the client application, the management application being a cloud-based application. A first edge module is deployed onto at least one computing device in a private network, the edge module being configured to communicate with the management application. The first edge module accesses private network data associated with at least one private network application. The private network data is encrypted on the first edge module using a passphrase provided to the first edge module from the client application via the management application. The encrypted private network data is transmitted from the first edge module to the client application via the management application.

### FIELD

The present disclosure is related to the field of digital certificate management, and more specifically, for managing certificates and data associated with applications and services running on a private network.

### BACKGROUND

Digital certificates such as Transport Layer Security (TLS) certificates and Secure Sockets Layer (SSL) certificates are often relied upon to provide safe and secure data transfers across the internet. TLS/SSL certificates can secure internet connections by encrypting data sent between browsers, websites, and servers. As such, TLS/SSL certificates must be renewed, replaced, or rotated to prevent outages to applications, services, and security infrastructure. However, it can be difficult to track and manage large inventories of certificates associated with applications and services distributed across public and/or private networks.

### SUMMARY

Systems and methods for providing access to applications and services running on a private network are disclosed. A method for providing secure access to private network applications includes providing a client application accessible from a user device and a management application configured to communicate with the client application, the management application being a cloud-based application. A first edge module is deployed onto at least one computing device in a private network, the edge module being configured to communicate with the management application. The first edge module accesses private network data associated with at least one private network application. The private network data is encrypted on the first edge module using a passphrase provided to the first edge module from the client application via the management application. The encrypted private network data is transmitted from the first edge module to the client application via the management application.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a block diagram of a management system for monitoring network applications and services in accordance with aspects described herein;

FIG. 2 is a dashboard of an example certificate inventory in accordance with aspects described herein;

FIG. 3 is an example sequence for installing an edge module in accordance with aspects described herein;

FIG. 4 is an example sequence for generating a data encryption key in accordance with aspects described herein;

FIG. 5 is an example sequence for sharing a data encryption key in accordance with aspects described herein;

FIG. 6 is an example sequence for validating credentials associated with an application or certificate authority in accordance with aspects described herein;

FIG. 7 is an example sequence for generating keys and a certificate signing request in accordance with aspects described herein;

FIG. 8 is an example sequence for downloading a private network certificate in accordance with aspects described herein;

FIG. 9A illustrates an example traffic flow including a worker module in accordance with aspects described herein;

FIG. 9B illustrates an example sequence for installing and pairing a worker module in accordance with aspects described herein;

FIG. 10 illustrates a functional block diagram of a management architecture in accordance with aspects described herein; and

FIG. 11 is a block diagram of an example computer system in accordance with aspects described herein.

### DETAILED DESCRIPTION

Disclosed herein are exemplary embodiments of systems and methods for providing access to applications and services running on a private network, and more specifically, for managing digital certificates and data associated with the applications and services running on the private network.

Digital certificates such as Transport Layer Security (TLS) certificates and Secure Sockets Layer (SSL) certificates are often relied upon to provide safe and secure data transfers across the internet. TLS/SSL certificates can secure internet connections by encrypting data sent between browsers, websites, and servers. They ensure that data is transmitted privately and without modifications, loss or theft. Applications secured by TLS/SSL certificates are generally trusted by users because they encrypt and protect private information transferred to and from the application. They may also represent and/or certify the application's (or associated website's) brand identity. As such, TLS/SSL certificates are an identity protection measure for online websites, applications, and services, as well as a security measure for users/companies transmitting private data online.

Secure communication may begin with a handshake (e.g., a TLS/SSL handshake), in which two communicating parties open a secure connection and exchange a public key. During the handshake, the two parties generate session keys, and the session keys are used to encrypt and decrypt all communications after the handshake. Different session keys may be used to encrypt communications in each new session. The TLS/SSL certificate is used to verify the party on the server side, or the website/application the user is interacting with, is actually who they claim to be. The TLS/SSL certificate may be issued and validated by a third-party certificate authority (CA). A certificate issued by a CA binds a particular public key to the name of the entity the certificate identifies, such as the name of an employee, website, or a server. Only the public key certified by the certificate works with the corresponding private key possessed by the entity identified by the certificate. In addition to the public key, the certificate includes the name of the entity it identifies, an expiration date, the name of the CA that issued the certificate, a serial number, the digital signature of the issuing CA, and other information. The CA's digital signature allows the certificate to function as an identifier for users who know and trust the CA but don't know or trust the entity identified by the certificate.

TLS/SSL certificates typically expire after a set period of time (e.g., 1-5 years). In some cases, certain websites may no longer trust certificates issued for longer than a predetermined period of time (e.g., 1 year). Once the certificate has expired (or becomes untrusted), many web browsers will present users with a security warning, asking them to manually confirm the authenticity of the certificate chain. In some cases, software or automated systems may silently refuse to connect to the server associated with the certificate. As such, TLS/SSL certificates must be renewed, replaced, or rotated to prevent outages to applications, services, and security infrastructure. However, it can be difficult to track and manage large inventories of certificates and data associated with applications and services distributed across public and private networks.

Accordingly, systems and methods for providing access to applications and services running on a private network are provided herein. In at least one embodiment, an edge module is deployed in a computing environment within a private network. The edge module is configured to securely transmit information associated with applications and services running in the private network to a cloud management application. In some examples, the edge module is configured to discover and validate digital certificates, provide integration with enterprise certificate authorities (CAs), and provide integration with enterprise application servers for certificate installation and rotation.

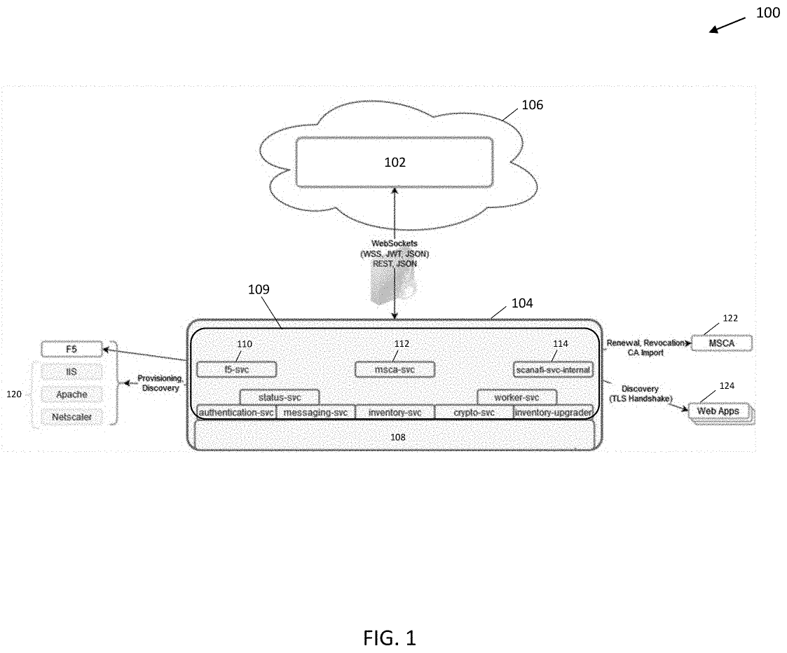

FIG. 1 is a block diagram illustrating a management system 100 for monitoring network applications and services. In one example, the management system 100 enables a user (or users) to track and manage TLS/SSL certificates associated with applications and services. The management system 100 is configured to discover and inventory TLS/SSL certificates found both in public and private networks. In some examples, the management system 100 is configured to identify and notify the user(s) of potential certificate problems before they lead to outages and/or security breaches.

In one example, the management system 100 includes a management application 102. The management application 102 may run in a cloud-based computing environment 106. In some examples, the management application 102 can be implemented with a managed container service (e.g., Amazon Elastic Kubernetes Service). The management application 102 can include one or more application containers. In some examples, the management application 102 includes one or more applications, services, microservices, or modules. For example, the management application 102 may include Java, Spring Boot, Jersey, Spring Data, or any other suitable type of microservices. In addition, the management application 102 may provide an API (or API gateway) enabling the microservices to communicate with other applications, services, or devices running on public/private networks. In some examples, one or more of the services (or microservices) of the management application 102 may include functions that run within the management application 102 and/or a browser-based application or interface in communication with the management application 102 (e.g., of a client application running on a client device).

The management application 102 can include a variety of applications and services configured to provide functions associated with applications running on public and private networks. For example, the management application 102 may include a discovery service (or module). The discovery service of the management application 102 is configured to discover (or identify) server certificates associated with an entity (e.g., user, organization, company, etc.). To discover public certificates or certificates that are used outside of the entity's private network, an internet discovery service may be used. For example, domains, external Fully Qualified Domain Names (FQDNs), external IP addresses, and/or Classless Inter-Domain Routing (CIDR) ranges may be added as targets for the internet discovery service. In certain examples, the internet discovery service can be scheduled such that the discovery of external certificates is performed automatically. In other examples, the internet discovery service can be run on demand (e.g., by user request).

To discover private certificates or certificates that are used within the entity's private network, a private discovery process may be performed. In one example, the private discovery process includes running a private discovery tool on one or more endpoints (e.g., computing environments) of the private network that are not reachable from the public internet. In some examples, the private discovery tool is a lightweight command line tool that enables the user to scan hosts on the internal network for SSL/TLS certificates. The discovery tool may be a single executable file compatible with Windows, Linux, and MacOS operating systems. In one example, the private discovery tool performs certificate discoveries over a specific network port(s) (e.g., port 443 or additional well-known ports) via SSL/TLS and STARTTLS handshakes. The discovery tool may also test for the presence of known vulnerabilities such as DROWN, Heartbleed, logjam, poodle, poodle TLS, etc. In an online mode, the private discovery tool is configured to provide automatic transmission of the certificate discovery results to the management application 102 (e.g., via an API call portion of the command line operation). In one example, the transmission of the certificate discovery results occurs over HTTPS and authentication credentials (e.g., an API token) may be validated before the results are provided to the management application 102. In some examples, the API token is provided to the user during an install or registration processes of the management application 102. In an offline mode, all certificate discovery results are logged to a standard text file (e.g., in JSON format). This file can then be collected for out-of-band import to the management application 102 using the same API.

Once discovered, the certificates may be added to the entity's certificate inventory. The certificates in the certificate inventory can be assigned to specific applications or services by the user (e.g., via the management application 102).

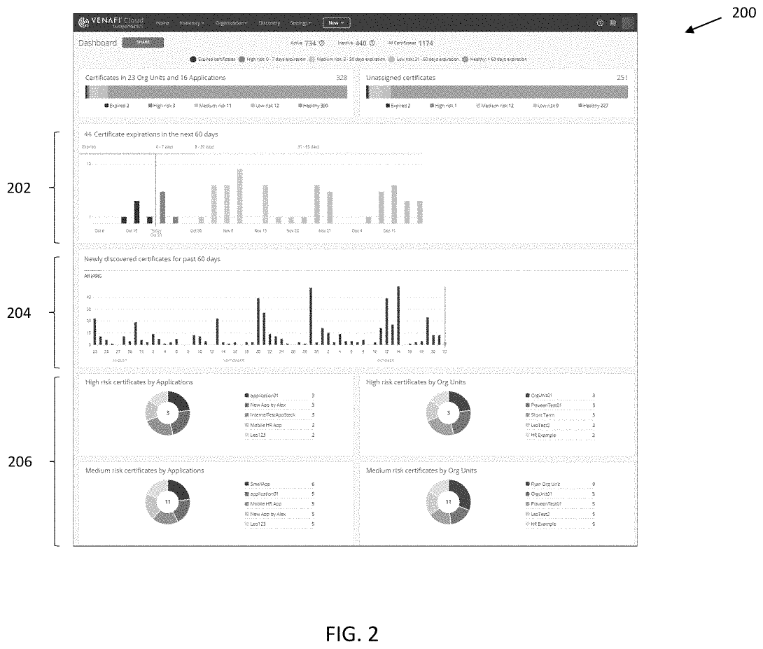

In some examples, the management application 102 is configured to provide a dashboard for observing and/or managing the certificate inventory. For example, FIG. 2 illustrates a dashboard 200 of an example certificate inventory provided by the management application 102. The dashboard 200 may be displayed in a browser or user interface (UI). In one example, the certificates are classified as “active” or “inactive”. In some examples, color coding can be used to indicate a risk associated with each certificate. For example, the color “green” may indicate a healthy or low risk certificate whereas the color “red” may indicate a high risk certificate (e.g., nearing expiration). The dashboard 200 can include graphs or other visualizations to indicate various metrics to the user. For example, graph 202 is used to indicate the estimated volume of certificate expirations over time (e.g., the next 60 days). Likewise, graph 202 indicates the frequency (or rate) of new certificate discoveries over time (e.g., the last 60 days). Graph 206 provides an indication of high and medium risk certificates grouped by application types (e.g., “Mobile HR App”) and organization types (e.g., “OrgUnit01”). In some examples, the dashboard 200 is updated by the management application 102 on a regular interval (e.g., daily). In other examples, the dashboard 200 can be updated on demand (e.g., by user request).

As described above, private certificates can be discovered by manually executing the private discovery tool on one or more private network endpoints. However, private certificate searches may be performed less frequency than public certificate searches due to this manual process. For example, private network endpoints may be distributed across different geographic regions. As such, it can be difficult to maintain an accurate inventory of private certificates which may lead to increased outage risks. In addition, the transfer of private certificate results to the management application 102 depends on an individual user's API access, introducing additional security vulnerabilities. For at least these reasons, it may be advantageous to provide a localized, automated solution for discovering and managing private certificates, as well as data associated with private network applications.

In one example, the management system 100 includes an edge module 104. The edge module 104 may alternately be referred to as a satellite or satellite module. The edge module 104 is configured to provide automated discovery and management of private network certificates and data associated with private network applications. In some examples, the edge module 104 includes an execution environment that enables applications, services, microservices, or modules to run on private network devices. The edge module 104 operates as a self-updating application that is a runtime extension of management application 102 within on-premises/private networks and machines. The edge module 104 can provide access to network applications and services running on an entity's private network(s) (i.e., “inside the firewall”) without weakening their security posture. In some examples, applications, services (or microservices) or modules can be pushed (or downloaded) to the edge module 104 from the management application 102. The applications or services pushed to the edge module 104 may correspond to specific preferences of the entity (or users) associated with the edge module 104. For example, the edge module 104 can include modules or services for scanning for SSL/TLS certificates (i.e., “discovery and validation”), integration with enterprise certificate authorities (CAs), and integration with enterprise application servers for certificate installation and rotation.

As described above, the edge module 104 is configured to run on designated user-controlled machines (e.g., Linux systems, Windows systems, MacOS systems, or other computing devices) within the private network. As such, the edge module 104 is capable of generating new cryptographic keys for securing user/entity applications and services. In some examples, the edge module 104 is responsible for encrypting/decrypting information such that data can be securely exchanged between the edge module 104, the management application 102, and/or other edge module instances, as described in greater detail below.

In one example, the edge module 104 is a self-contained, low-footprint, Kubernetes-based application runtime (e.g., execution environment). In some examples, the edge module 104 may only require user intervention during installation (and deinstallation). Installation of the edge module 104 may start by downloading a command line utility called “vsatctl” from the management application 102 to the user-controlled endpoint that will be hosting it. The management application 102 provides the full “vsatctl” installation command which includes a temporary, one-time use pairing code that allows the edge module 104 to be added to the user's (or entity's) account at the time of installation. In some examples, the paring code may expire after a fixed amount of time. In certain examples, to facilitate rapid deployment of multiple edge modules 104, the pairing code can be reused across multiple edge modules. The pairing code may be provided to the user via a browser-based application or interface in communication with the management application 102.

During installation, the “vsatctl” installs a container orchestration system 108 (e.g., k3s, Helm, etc.) and the deploys several foundational microservices that provide core functionality and facilitate interactions with the management application 102. In one example, a software bill of materials including a core set of services is automatically distributed to the edge module 104 (e.g., in response to the pairing code being validated). In some examples, the edge module 104 is configured to validate the bill of materials before commencing download or installation of the core set of services. The management application 102 may initiate a health check to verify that the core set of services has been successfully installed on the edge module 104. In some examples, the health check can be performed periodically (e.g., at a regular interval) and reconciliation may be performed without interruption to the edge module 104. As described above, additional microservices and applications may be pushed to the edge module 104 from the management application 102 based on entity (or user) preferences. In some examples, each edge module 104 deployed can be assigned a unique name during or after installation for easy identification.

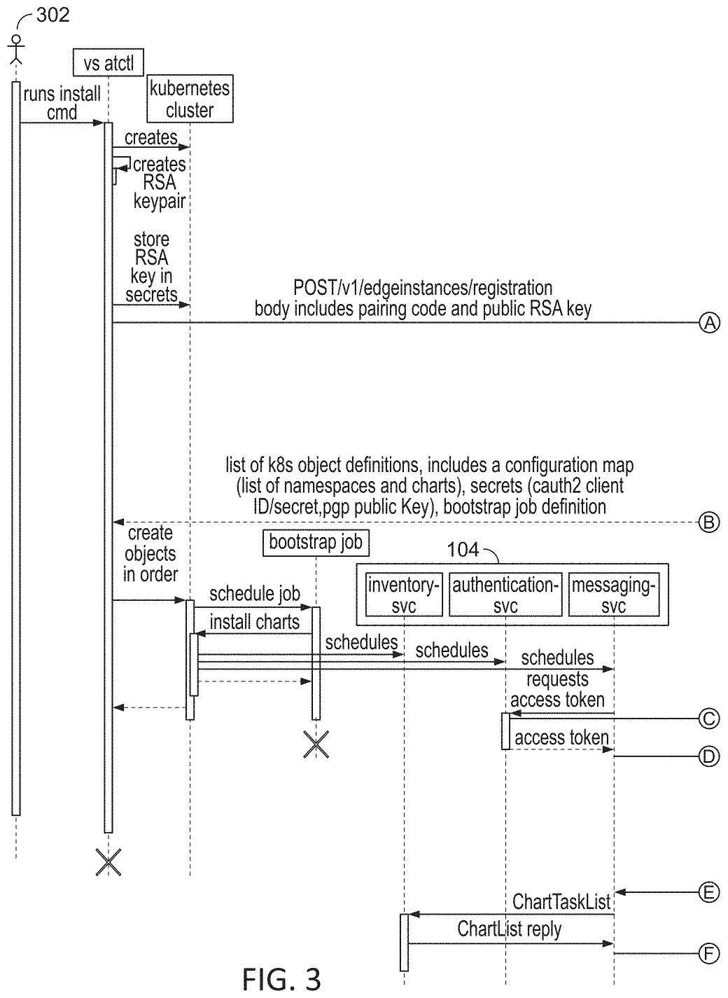

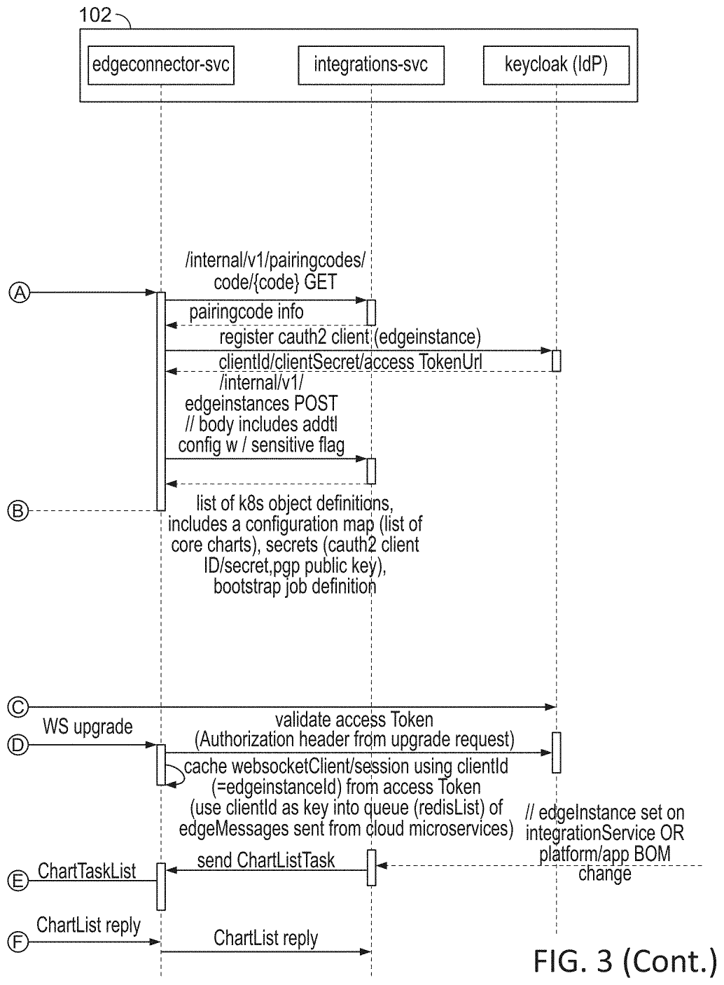

In one example, the user can submit a request to install the edge module 104 via a user interface (e.g., dashboard 200), application, or a browser in communication with the management application 102. For example, FIG. 3 illustrates an example sequence 300 in which a user (or entity) 302 requests installation of the edge module 104. As shown, the edge module 104 may be configured to communicate with the management application 102 during installation. After successful installation, application-specific microservices, like those for discovery and key generation, can be added and/or removed from the edge module 104 based upon user/entity entitlements (licensing) and preferences.

The edge module 104 can include a variety of applications and services configured to provide different functions associated with applications running on the private network. As shown in FIG. 1, the edge module 104 can include: a status service, an authentication service, a messaging service, an inventory service, a cryptographic service, and/or an inventory upgrader. In one example, one or more services may be installed or established on the edge module 104 during installation and may contribute to the instantiation of the edge module 104. For example, the messaging service is one of the first services that is installed/established on the edge module 104 and handles communications (e.g., to the management application 102) for instantiating the edge module 104. Likewise, the inventory service may provide an inventory of applications and services on the edge module 104 that is referenced by the management application 102 for reconciliation (e.g., during a health check).

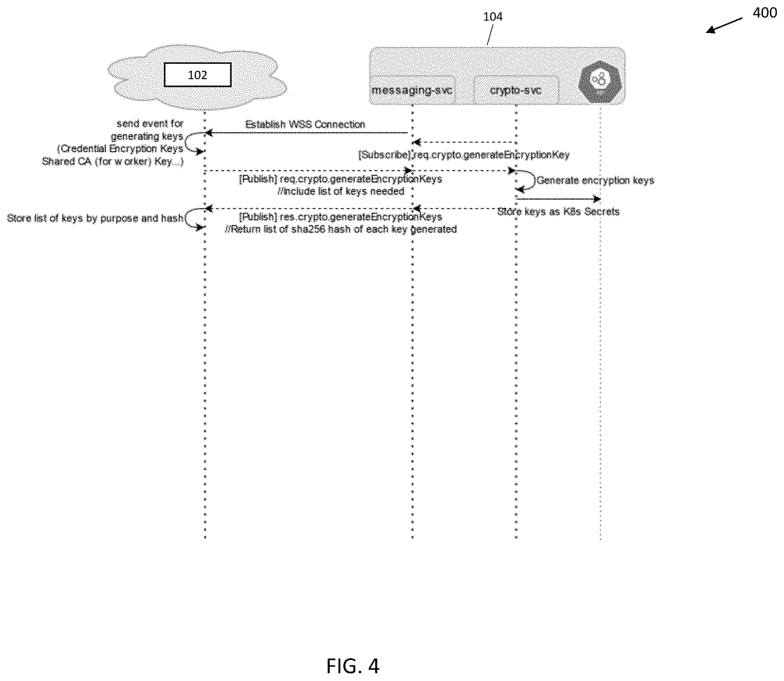

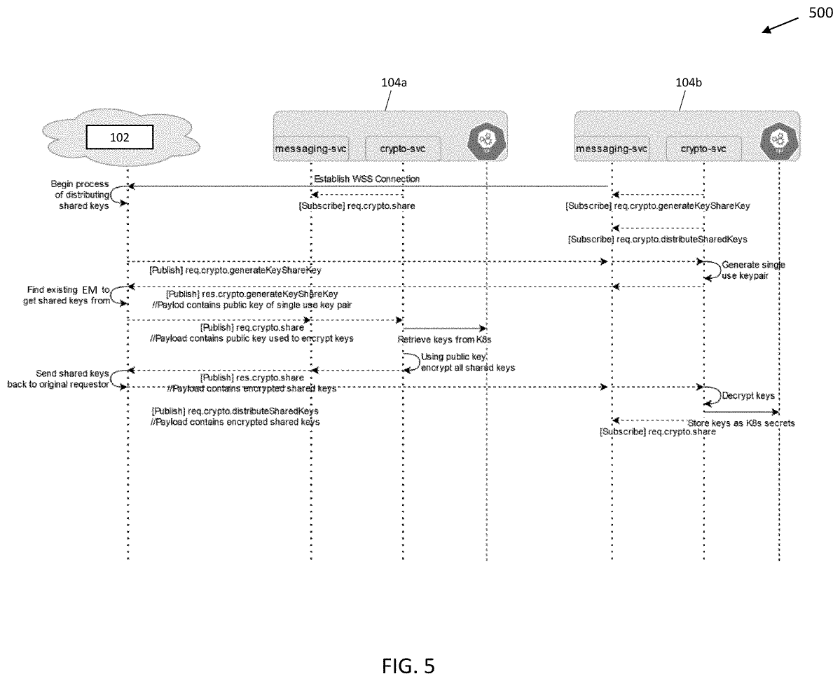

Following installation of the edge module 104, a Data Encryption Key (DEK) is generated. In one example, the DEK is an asymmetric keypair including a private key (e.g., SHA-256 digest) and a public key. The DEK can be shared with all edge modules that are subsequently installed in the private network such that all edge modules use the same DEK. It should be appreciated that the DEK is not stored by the management application 102. FIG. 4 illustrates an example sequence 400 for generating a DEK between the management application 102 and the edge module 104. In one example, the messaging service and the cryptographic service of the edge module 104 are used to generate the DEK. Similarly, FIG. 5 illustrates an example sequence 500 for sharing a DEK between the management application 102, an existing edge module 104a, and a new edge module 104b. As shown, the messaging service and the cryptographic service of the edge modules 104a, 104b are used to share the DEK. In some examples, the DEK is backed up immediately after deployment of the first instance of the edge module 104.

In some examples, the DEK enables services and modules running on the edge module 104 to securely communicate with the management application 102 and client applications (e.g., user applications). For example, the DEK may be used to encrypt/decrypt data for various functions including: encrypting stored credentials for integrations with enterprise CAs and/or enterprise application servers, encrypting private key material for certificates issued with generated private keys, providing a mechanism to comply with encryption compliance standards, and providing the ability to restore private key material in the case of catastrophic network failures or loss of the edge module 104.

In one example, each user or entity may have an account for managing the edge module 104. The account may be used to log-in to or access a web portal, browser application, or other types of user interfaces that allows the edge module 104 to be managed via the management application 102. As such, the edge module 104 can be remotely managed from the entity's (or user's) account. For example, full administration and management of services for the edge module 104 may performed through the management application 102. In some examples, entity accounts can include multiple user accounts allowing different members of an organization or company to manage the edge module 104. In certain examples, different accounts may have different access privileges.

In some examples, a plurality of edge modules 104 can be deployed throughout the private network (e.g., on different endpoints or machines) to provide comprehensive access to internal applications and services. In some examples, being that the edge modules 104 are lightweight and disposable (e.g., stateless), users may easily add, remove, and reconnect them from the management application 102. In addition, the status (and logs) of connected edge modules 104 can be monitored via the management application 102. Monitoring can include viewing the status of the edge module 104, verifying the last time the edge module 104 checked in to the management application 102, and viewing the active (or supported) services on the edge module 104 (e.g., health check).

In one example, different instances of deployed edge modules 104 can be organized with different environments. The environment of the edge module 104 may correspond to a container 109 of the edge module 104 (and associated services) that is designed to model logical/physical environments of the entity. For example, the environment may correspond to a Golang, Redis, CertManager, gRPC, REST, Web Sockets, or any other suitable type of application container on the edge module 104. In one example, an environment may reflect a geo-centric configuration, representing all the physical/logical devices and services hosted at a data center in Santa Clara, Calif. In another example, an environment may represent the collection of network devices in a user's (or entity's) production workloads.

As described above, the services (or microservices) of the edge module 104 correspond to the live machine identity management functions that run inside of the edge module 104. In some examples, services are hosted in the environment(s) (or container 109) of the edge module 104. In one example, the edge module 104 can include a provisioning service 110, a management service 112, and a discovery service 114. The provisioning service 110 is configured to provide/configure new or existing certificates for third-party enterprise applications or servers running on the private network. For example, the provisioning service 110 may provision certificates to a plurality of enterprise assets 120 including F5 applications, Internet Information Services (IIS), Apache web servers, application delivery controllers (ADC) (e.g., NetScaler), and other types of applications and servers configured for use within private networks. In certain examples, the provisioning service 110 may rotate certificates between the enterprise assets. In some examples, the provisioning service 110 may also discover (or search) for certificates within the plurality of enterprise assets 120. In one example, the management service 112 is configured to renew certificates, revoke certificates, and import certificates and data from one or more CAs 122 (e.g., MSCA). In some examples, the management service provides integration between the edge module 104 and the one or more CAs 122. Likewise, the discovery service 114 is configured to perform an automated discovery search for certificates associated with applications and services within the private network. Such applications and services may include microservices running in distributed application containers on the private network. In some examples, the discovery search may include applications and services associated with the host-system that the edge module 104 is implemented on. The automated discovery search may be performed at regularly intervals (e.g., daily) or on demand.

Data received, accessed, retrieved, or collected by the edge module 104 can be transmitted (or transferred) to the management application 102 for further processing, organization, or display (e.g., via the dashboard 200 or another user interface). In one example, the edge module 104 can send encrypted or unencrypted data to the management application 102 via an API or communication protocol (e.g., WebSocket). The data may be transmitted using a data-interchange format (e.g., WSS, JWT, JSON, REST, etc.). Likewise, the edge module 104 may receive encrypted or unencrypted data from the management application 102 in the same manner. In one example, the encrypted data may be decrypted based on DEK on the edge module 104.

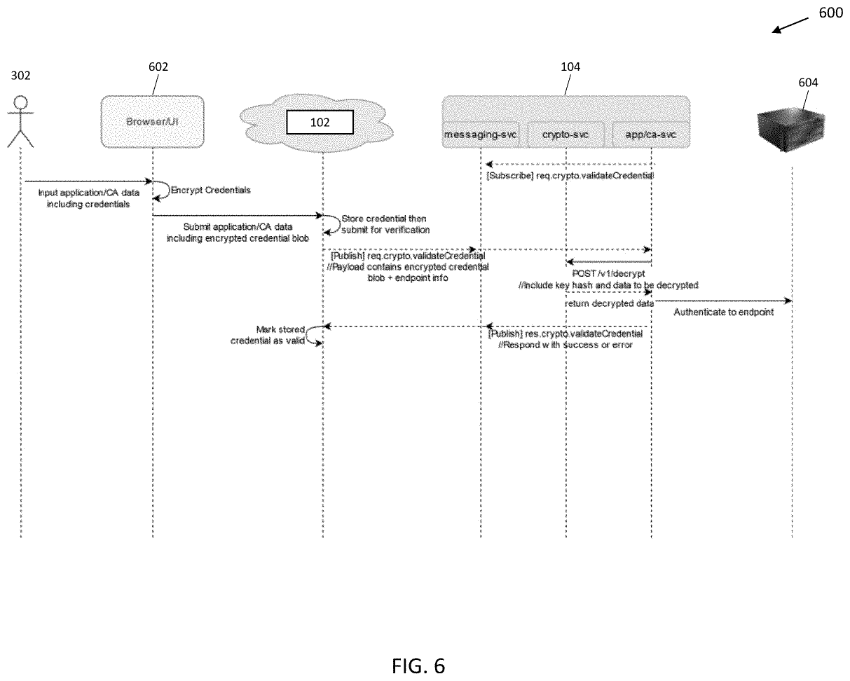

In one example, one or more services included on the edge module 104 can be used to validate credentials associated with a private network application or a CA associated with one or more digital certificates used by the private network application. FIG. 6 is an example sequence 600 for validating credentials associated with an application or CA. As shown, the user (or entity) 302 may input application or CA data including the credentials via a browser/UI 602 (e.g., dashboard 200). The credentials are exchanged between the management application 102, the edge module 104, and an application/CA endpoint 604 for validation. In one example, the messaging service, the cryptographic service, and an application/CA service of the edge modules 104a, 104b are used to validate the credentials.

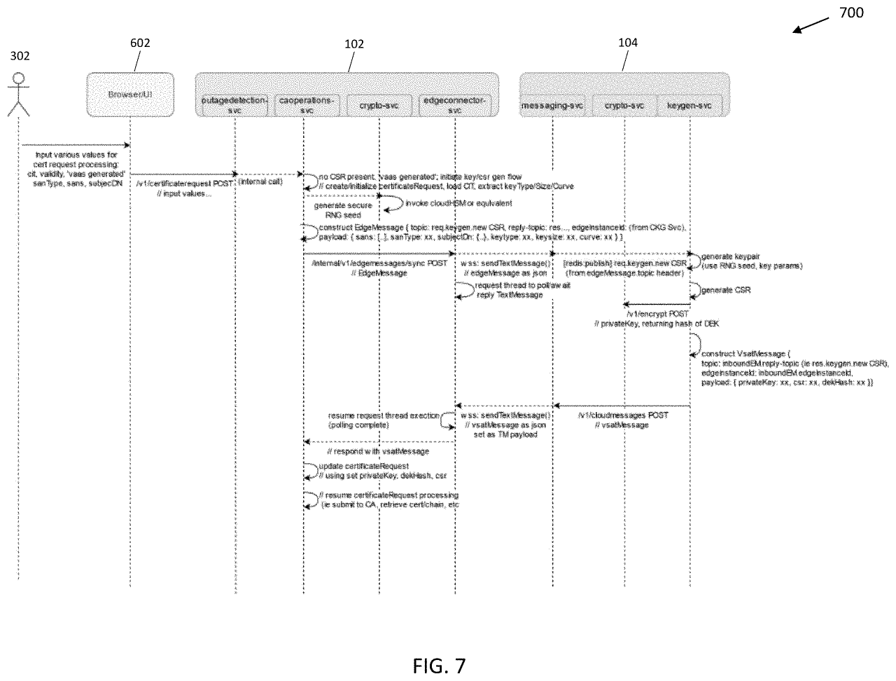

In another example, one or more services included on the edge module 104 can be used to generate one or more keys and/or certificate signing requests (CSRs) associated digital certificates used by private network applications. FIG. 7 is an example sequence 700 for generating keys and a certificate signing request (CSR) when a new certificate is requested from the certificate inventory. As shown, the user (or entity) 302 may input parameters for the new certificate request via the browser/UI 602. The parameters are exchanged between the management application 102 and the edge module 104 to generate keys and a CSR for the request. In one example, the messaging service, the cryptographic service, and a keygen service of the edge module 104 are used to generate the keys and CSR.

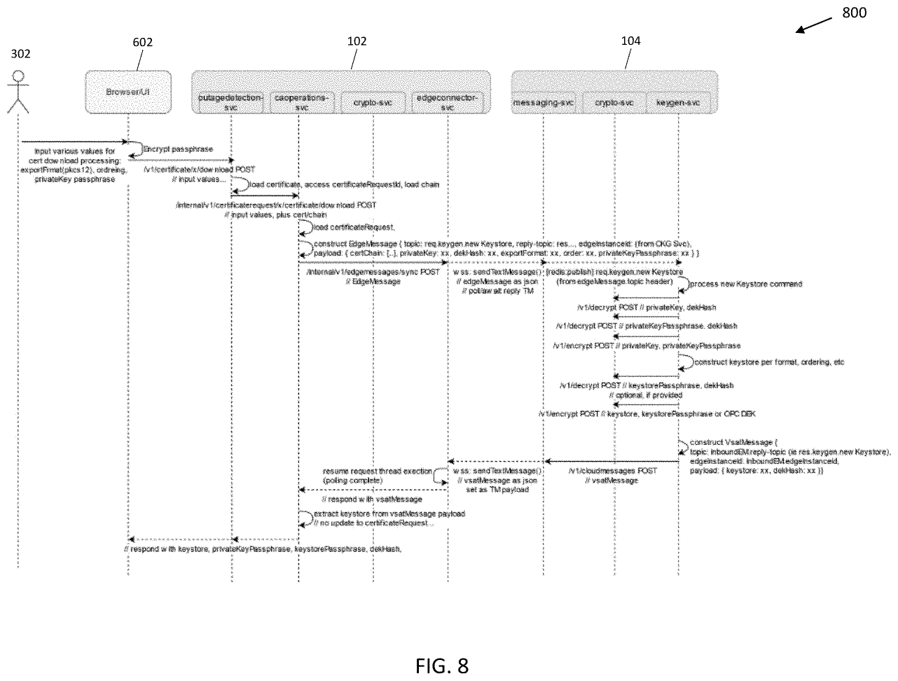

In some examples, one or more services included on the edge module 104 can be used to download a digital certificate keystore (e.g., a data structure for storing cryptographic keys and certificates) used by (or for use with) a private network application. FIG. 8 is an example sequence 800 for downloading digital certificate keystore from an entity's certificate inventory. As shown, the user (or entity) 302 may input parameters for the certificate download request via the browser/UI 602. The parameters are exchanged between the management application 102 and the edge module 104 to process the request. In one example, the messaging service, the cryptographic service, and the keygen service of the edge module 104 are used to retrieve the keystore associated with the private network certificate.

In some examples, the management application 102 can utilize middleware to enable interactions with legacy applications or other applications (or services) that are not directly supported by the API (e.g., the API used by the management application 102 and/or the edge module 104). In one example, the edge module 104 may communicate with a worker module configured to interact with the specific application/service (e.g., Microsoft ADCS).

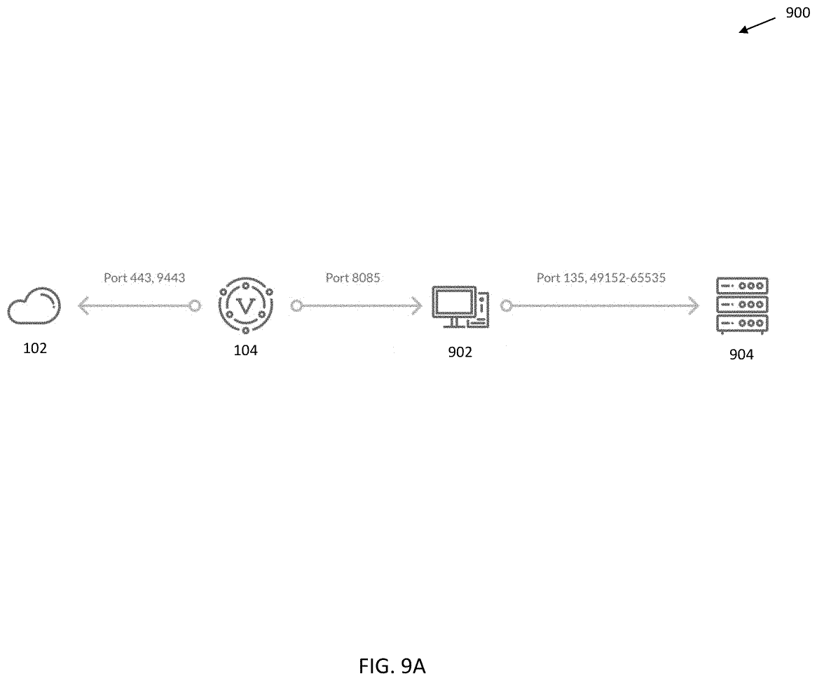

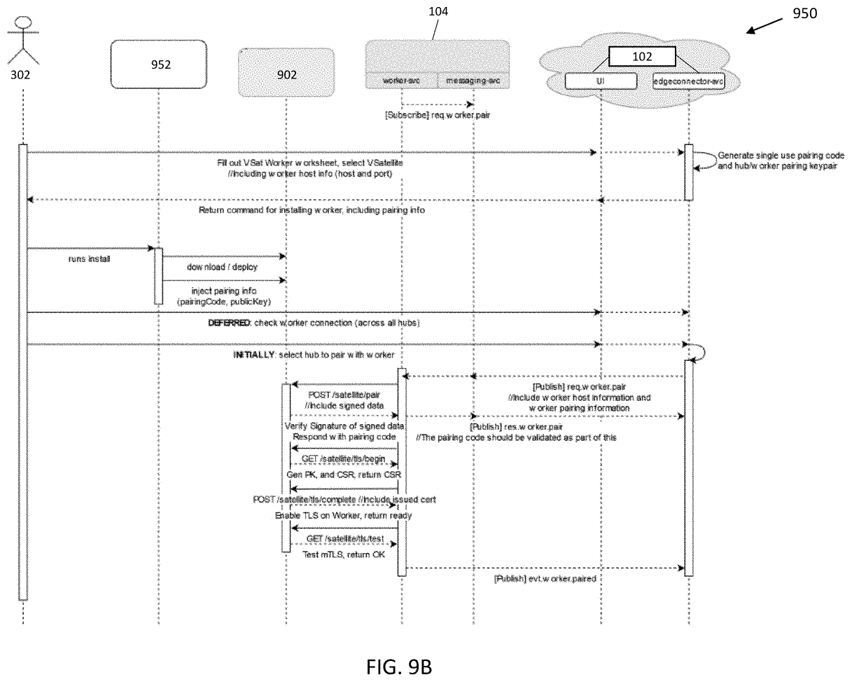

FIG. 9A illustrates an example traffic flow 900 including a worker module 902 that is tied to the edge module 104. In one example, the build of the worker module 902 is substantially similar to the build of the edge module 104. As shown, the management application 102 can communicate with an application 904 via the edge module 104 and the worker module 902. In one example, the edge module 104 is configured to receive data from the management application 102 and forward the received data to the worker module 902. In some examples, the edge module 104 may reformat or package the data before forwarding to the worker module 902. The worker 902 is configured to receive the data from the edge module 104 and reformat or package the received data for communication with the application 904. Likewise, data may be received from the application 904 and returned to the management application 102 in a similar manner. In some examples, the data traffic between the management application 102 and the edge module 104, the edge module 104 and the worker module 902, and the worker module 902 and the application 904 may occur across different network ports (e.g., Port 443, 8085, etc.).

FIG. 9B is an example sequence 950 for installing and pairing a worker module 902. As shown, the user (or entity) 302 may input parameters for the worker module 902 via a browser/UI of the management application 102 (e.g., dashboard 200). The management application 102 can initiate an install package 952 for installing the worker module 902. The parameters are exchanged between the management application 102, the edge module 104, and the worker module 902 for pairing the worker module 902 to the edge module 104. In one example, the messaging service and a worker service of the edge module 104 is used to pair the worker module 902.

As described above, a plurality of edge modules 104 can be installed across the private network. In some examples, the edge modules 104 may communicate with intermediate hubs configured to aggregate and relay data/information to the management application 102. In some examples, the intermediate hubs are cloud-based applications; however, in other examples the intermediate hubs may be installed on one or more user-controlled host systems (e.g., endpoints).

In one example, the deinstallation process for the edge module 104 includes deleting the object representing it from the management application 102 and executing an “vsatctl uninstall” command from the user-controlled host system. However, the user may quickly terminate the edge module 104 by shutting down or destroying the system hosting it. The management application 102 cannot generate or decrypt keys without at least one active edge module, so taking all edge modules offline effectively renders useless all of the entity's private key material and data stored in the management application 102.

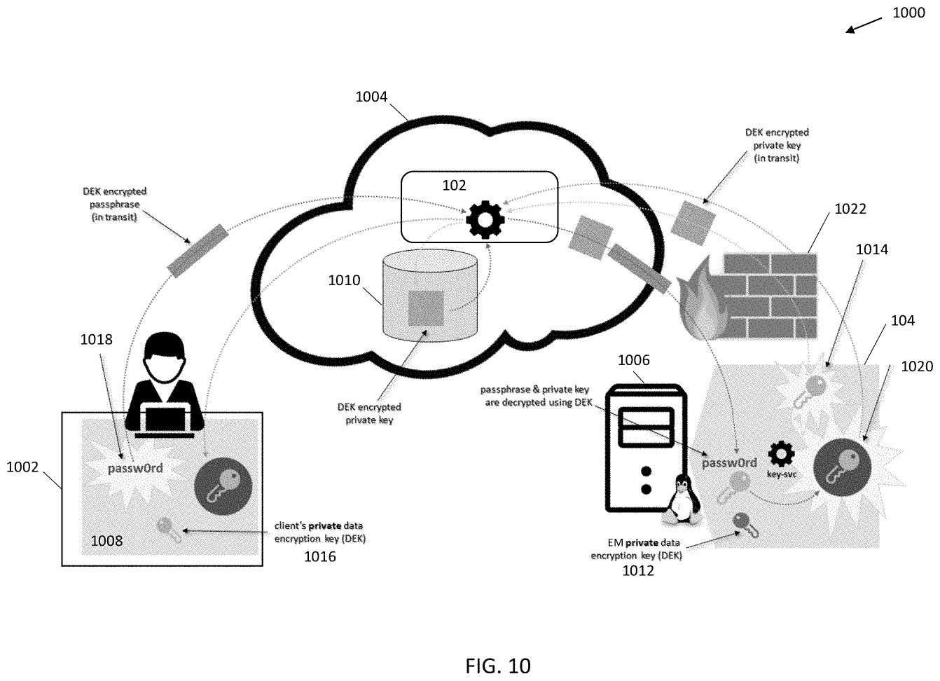

FIG. 10 is a functional block diagram illustrating a management architecture 1000 for monitoring network applications and services. In one example, the management architecture includes the management application 102 and the edge module 104 of FIG. 1. In some examples, the management architecture 1000 can provide secure transmission of data (passcodes, keys, secrets, etc.) between a client interface and private network devices.

As shown, the management architecture 1000 includes a user device 1002, a cloud environment 1004, and a private network device 1006. The user device 1002 may be a smart phone, a tablet computer, a smart watch, a laptop computer, a desktop computer, or other similar internet enabled devices. In one example, the user device 1002 is configured to display or present a client application 1008 to the user. The client application 1008 can be presented to the user via an internet browser or as another application running on the user device 1002. In some examples, the dashboard 200 of FIG. 200 may be included in the client application 1008.

In one example, the management application 102 is configured to run in the cloud environment 1004. The cloud environment 1004 may correspond to the cloud-based computing environment 106 of FIG. 1. In some examples, the management application 102 is configured to communicate with the user device 1002 (or the client application 1008) via a public network (e.g., the internet). In one example, the management application 102 includes a database 1010; however, in other examples, the management application 102 can communicate with an external database (e.g., a cloud or server-based database).

In one example, the edge module 104 is configured to run on the private network device 1006. The private network device 1006 may be a smart phone, a tablet computer, a smart watch, a laptop computer, a desktop computer, or other similar network enabled devices. In some examples, the private network device 1006 corresponds to a Linux computing environment; however, in other examples, the private network device 1006 may correspond to other computing environments (e.g., Windows, MacOS, etc.).

As described above, the edge module 104 may generate a DEK 1012 following installation on the private network device 1006. In one example, a key service of the edge module 104 is configured to generate a private key 1012. The private key 1012 can be encrypted using the DEK 1012 and securely transmitted to the management application 102. The encrypted private key 1012 may be stored (e.g., “at rest”) in the database 1010. It should be appreciated that the private key 1012 is stored in an encrypted state and that the management application 102 (or the database 1010) does not have access to the raw key material/data. As such, the encrypted private key 1012 can be stored in the cloud and provisioned, shared, or re-downloaded. In some examples, the encrypted private key 1012 can only be decrypted by the edge module 104, giving users the ultimate control over whether or when the private key is decrypted. For example, the user may destroy the edge module 104 (or a plurality of edge modules 104) to ensure the private key(s) are never again obtained using the management application 102.

In some examples, key (or certificate) materials can be requested by the user (or the client application 1008) from the edge module 104 to secure one or more applications. For example, the client application 1008 may request a public key and create a secure vault and seal with the public key. In other examples, different types of data associated with private network applications or digital certificates can be requested by the user via the client application 1008.

In one example, user-specific (or client specific) credentials are used to carry out the request(s). For example, the user can enter a user-specified passphrase (or token) 1018 via the client application 1008. In other examples, the passphrase 1018 may be generated automatically by the client application 1008. In one example, the passphrase 1018 can be encrypted using a DEK 1016 associated with the client application 1008 and securely transmitted to the management application 102. The DEK 1016 associated with the client application 1008 may be the same or related to the DEK 1012 of edge module 104. For example, the DEK 1016 may correspond to a version (e.g., an encrypted version) of the DEK 1012 or a portion of the DEK 1012 provided via the management application 102. In other examples, the DEK 1016 may be generated locally by the client application 1008 (or the user device 1002). Upon receipt of the encrypted passphrase 1018, the management application 102 may forward the encrypted passphrase 1018 and the encrypted private key 1012 to the edge module 104. In one example, the edge module 104 is configured to decrypt the private key 1012 and the passphrase 1018 using the DEK 1012. The edge module 104 can access (or retrieve) data from the private network associated with the user request (e.g., public key request) and encrypt the data using the passphrase 1018. In one example, the encrypted data includes a keystore 1020 associated with one or more digital certificates. Once encrypted, the keystore 1020 can be transmitted to the client application 1008 via the management application 102. In some examples, the keystore 1020 can be decrypted by the client application 1008 using the passphrase 1018. For example, the keystore 1020 may be decrypted in the vault created by the client application 1008. The key and/or certificate material included in the keystore 1020 may be used to secure one or more applications. It should be appreciated that the encrypted communication between the management application 102 and the edge module 104 occurs over a public network (e.g., the internet). In addition, the encrypted communication between the management application 102 and the edge module 104 may occur through a firewall 1022 associated with the private network device 1006.

As described above, systems and methods for providing access to applications and services running on a private network are provided herein. In at least one embodiment, an edge module is deployed in a computing environment within a private network. The edge module is configured to securely transmit information associated with applications and services running in the private network to a cloud management application. In some examples, the edge module is configured to discover and validate digital certificates, provide integration with enterprise certificate authorities (CAs), and provide integration with enterprise application servers for certificate installation and rotation.

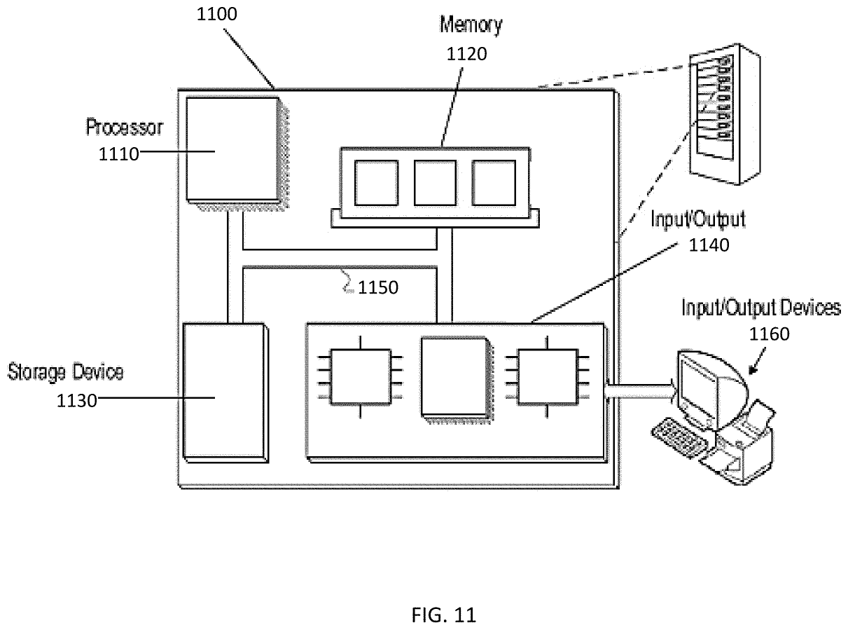

FIG. 11 is a block diagram of an example computer system 1100 that may be used in implementing the systems and methods described herein. General-purpose computers, network appliances, mobile devices, or other electronic systems may also include at least portions of the system 1100. The system 1100 includes a processor 1110, a memory 1120, a storage device 1130, and an input/output device 1140. Each of the components 1110, 1120, 1130, and 1140 may be interconnected, for example, using a system bus 1150. The processor 1110 is capable of processing instructions for execution within the system 1100. In some implementations, the processor 1110 is a single-threaded processor. In some implementations, the processor 1110 is a multi-threaded processor. The processor 1110 is capable of processing instructions stored in the memory 1120 or on the storage device 1130.

The memory 1120 stores information within the system 1100. In some implementations, the memory 1120 is a non-transitory computer-readable medium. In some implementations, the memory 1120 is a volatile memory unit. In some implementations, the memory 1120 is a nonvolatile memory unit. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

The storage device 1130 is capable of providing mass storage for the system 1100. In some implementations, the storage device 1130 is a non-transitory computer-readable medium. In various different implementations, the storage device 1130 may include, for example, a hard disk device, an optical disk device, a solid-date drive, a flash drive, or some other large capacity storage device. For example, the storage device may store long-term data (e.g., database data, file system data, etc.). The input/output device 1140 provides input/output operations for the system 1100. In some implementations, the input/output device 1140 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1160. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1130 may be implemented in a distributed way over a network, such as a server farm or a set of widely distributed servers, or may be implemented in a single computing device.

Although an example processing system has been described in FIG. 11, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

As described above, systems and methods for providing automation solutions for event logging and debugging on container orchestration platforms are provided herein. In at least one embodiment, the automated solutions include event logging and debugging on the KUBERNETES platform. In some examples, the solutions include the use of no-instrumentation telemetry, an edge intel platform, entity linking and navigation, command driven navigation, and a hybrid-cloud/customer architecture.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated from the described processes. Accordingly, other implementations are within the scope of the following claims.

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for providing secure access to private network applications, the method comprising:
providing a client application accessible from a user device;
providing a management application configured to communicate with the client application, the management application being a cloud-based application;
deploying a first edge module onto at least one computing device in a private network, the edge module being configured to communicate with the management application;
accessing, via the first edge module, private network data associated with at least one private network application;
encrypting the private network data on the first edge module using a passphrase provided to the first edge module from the client application via the management application; and
transmitting the encrypted private network data from the first edge module to the client application via the management application.

2. The method of claim 1, wherein the at least one private network application includes services and/or microservices running on the private network.

3. The method of claim 1, wherein the first edge module includes an execution environment and at least one service configured to run in the execution environment.

4. The method of claim 3, wherein accessing private network data associated with the at least one private network application includes collecting and/or retrieving private network data via the at least one service.

5. The method of claim 3, wherein the at least one service includes a discovery service configured to search for digital certificates associated with applications running on the private network.

6. The method of claim 5, wherein the digital certificates include TLS/SSL certificates.

7. The method of claim 1, wherein encrypting the private network data on the first edge module using the passphrase provided to the first edge module from the client application via the management application further includes:
generating a private key on the first edge module;
providing an encrypted version of the private key from the first edge module to the management application;
providing an encrypted version of the passphrase from the client application to the management application;
providing the encrypted versions of the private key and the passphrase from the management application to the first edge module;
decrypting the private key and the passphrase on the first edge module; and
encrypting the private network data using the decrypted passphrase on the first edge module.

8. The method of claim 7, wherein providing the encrypted version of the private key from the first edge module to the management application includes encrypting the private key using a data encryption key of the first edge module.

9. The method of claim 8, further comprising:
deploying a second edge module onto at least one second computing device in the private network; and
transferring a copy of the data encryption key from the first edge module to the second edge module via the management application.

10. The method of claim 7, wherein providing the encrypted version of the passphrase from the client application to the management application includes encrypting the passphrase using a data encryption key of the client application.

11. A system for providing secure access to private network applications, the system comprising:
at least one memory storing computer-executable instructions; and
at least one processor for executing the computer-executable instructions stored in the memory, wherein the instructions, when executed, instruct the at least one processor to:
provide a client application accessible from a user device;
provide a management application configured to communicate with the client application, the management application being a cloud-based application;
deploy a first edge module onto at least one computing device in a private network, the edge module being configured to communicate with the management application;
access, via the first edge module, private network data associated with at least one private network application;
encrypt the private network data on the first edge module using a passphrase provided to the first edge module from the client application via the management application; and
transmit the encrypted private network data from the first edge module to the client application via the management application.

12. The system of claim 11, wherein the at least one private network application includes services and/or microservices running on the private network.

13. The system of claim 11, wherein the first edge module includes an execution environment and at least one service configured to run in the execution environment.

14. The system of claim 13, wherein accessing private network data associated with the at least one private network application includes collecting and/or retrieving private network data via the at least one service.

15. The system of claim 13, wherein the at least one service includes a discovery service configured to search for digital certificates associated with applications running on the private network.

16. The system of claim 15, wherein the digital certificates include TLS/SSL certificates.

17. The system of claim 11, wherein encrypting the private network data on the first edge module using the passphrase provided to the first edge module from the client application via the management application further includes:
generating a private key on the first edge module;
providing an encrypted version of the private key from the first edge module to the management application;
providing an encrypted version of the passphrase from the client application to the management application;
providing the encrypted versions of the private key and the passphrase from the management application to the first edge module;
decrypting the private key and the passphrase on the first edge module; and
encrypting the private network data using the decrypted passphrase on the first edge module.

18. The system of claim 17, wherein providing the encrypted version of the private key from the first edge module to the management application includes encrypting the private key using a data encryption key of the first edge module.

19. The system of claim 18, wherein the instructions, when executed, further instruct the at least one processor to:
deploy a second edge module onto at least one second computing device in the private network; and
transfer a copy of the data encryption key from the first edge module to the second edge module via the management application.

20. The system of claim 17, wherein providing the encrypted version of the passphrase from the client application to the management application includes encrypting the passphrase using a data encryption key of the client application.
